(19) United States
(12) Patent Application Publication
(10) Pub. No.: US 2017/0093624 A1
(43) Pub. Date: Mar. 30, 2017

(54) Router Connectivity for Client Devices

(71) Applicant: QUALCOMM Incorporated, San Diego, CA (US)

(72) Inventors: Ramu Thondapu, Hyderabad (IN); Chaitanya Pratapa, Hyderabad (IN); Prasad Gadde, Hyderabad (IN); Rohit Tripathi, La Jolla, CA (US); Siddharth Gupta, San Diego, CA (US); Pranav Desai, San Diego, CA (US)

(21) Appl. No.: 14/865,772

(22) Filed: Sep. 25, 2015

(51) Int. Cl. H04L 12/24; H04L 29/12

(52) U.S. Cl. CPC H04L 41/0813; H04L 61/2015

(57) ABSTRACT

Described herein are apparatuses, methods, and computer readable media for configuring a router. An exemplary method comprises determining a first subnet associated with the router, the router having a first configuration setting; updating the first configuration setting for the router; in response to updating the first configuration setting, determining whether a second subnet is associated with the router; determining whether the router is connected to a client device that has a network address associated with the first subnet; and determining whether to disassociate the first subnet from the router based, at least in part, on whether the router is connected to the client device that has the network address associated with the first subnet.

### TECHNICAL FIELD

The present application generally relates to connecting routers to client devices.

### BACKGROUND

Facilities (e.g., homes, business establishments, etc.) generally have routers that provide Internet connectivity to their local networks based on backhaul connections offered by Internet Service Providers (ISP). Client devices within a local network can connect to a router (also referred to as customer-premises equipment (CPE)) through direct connections (e.g., direct Ethernet connections or Wi-Fi) and indirect connections (e.g., through a network bridge/switch). When a router's settings change, there is a need to ensure that both the direct connections and indirect connections to client devices are still supported by the router.

### SUMMARY

Described herein are various implementations of configuring a router. In some embodiments, a method is provided for configuring a router on a network. The method comprises determining a first subnet associated with the router, the router having a first configuration setting; updating the first configuration setting for the router; in response to updating the first configuration setting, determining whether a second subnet is associated with the router; determining whether the router is connected to a client device that has a network address associated with the first subnet; and determining whether to disassociate the first subnet from the router based, at least in part, on whether the router is connected to the client device that has the network address associated with the first subnet.

In some embodiments, router comprises a wired adapter, a wireless adapter, or a wide area network (WAN) adapter.

In some embodiments, the method further comprises disassociating the first subnet in response to determining that no client device has a network address associated with the first subnet.

In some embodiments, the method further comprises retaining the association of the first subnet in response to determining that the client device has a network address associated with the first subnet.

In some embodiments, the method further comprises determining whether the router is connected to the client device based on accessing a connected client devices list.

In some embodiments, the method further comprises determining whether to disassociate the first subnet when a second client device is removed from the connected client devices list.

In some embodiments, the connection between the router and the client device is a direct wired connection, an indirect wired connection, a direct wireless connection, or an indirect wireless connection.

In some embodiments, the first subnet does not overlap with the second subnet.

In some embodiments, the network address is associated with at least one Dynamic Host Configuration Protocol (DHCP) parameter.

In some embodiments, the router is connected to the client device that has the network address associated with the first subnet, further comprising notifying the client device of the second subnet.

In some embodiments, the router is connected to the client device that has the network address associated with the first subnet, and the method further comprises receiving, from the client device, a network address renewal request; and transmitting, to the client device, a network address associated with the second subnet, in response to receiving the network address renewal request from the client device.

In some embodiments, the router is connected to the client device that has the network address associated with the first subnet, and the method further comprises unicasting a message to the client device or broadcasting the message to multiple client devices.

In some embodiments, the router is connected to the client device that has the network address associated with the first subnet, and the method further comprises sending a message to the client device, wherein the client device determines whether to send a network address renewal request to the router based on the message.

In some embodiments, another method is provided for configuring a router on a network. The method comprises determining a first subnet associated with the router, the first subnet associated with a first group of network addresses, the first subnet having a first configuration setting; updating the router configuration setting for the router; in response to updating the first configuration setting for the router, associating a second subnet with the router, the second subnet associated with a second group of network addresses; transmitting a message to a network bridge, the message to cause the network bridge to toggle a connection to a client device that has a network address associated with the first subnet; receiving a network address renewal request from the client device; and transmitting a network address associated with the second subnet to the client device.

In some embodiments, toggling the network bridge comprises resetting the network bridge or deactivating and re-activating the network bridge.

In some embodiments, a router is provided. The router comprises a memory; and a processor, coupled to the memory, and configured to determine a first subnet associated with the router, the router having a configuration setting; determine whether the configuration setting of the router has changed; determine, in response to a determination that the configuration setting has changed, whether a second subnet is associated with the router; and determine whether to disassociate the first subnet from the router based, at least in part, on whether the router is connected to the client device that has the network address associated with the first subnet.

In some embodiments, the processor is further configured to disassociate the first subnet in response to determining that no client device has a network address associated with the first subnet.

In some embodiments, the processor is further configured to retain the association of the first subnet in response to determining that the client device has a network address associated with the first subnet. In some embodiments, the processor is further configured to determine whether the router is connected to the client device based on accessing a connected client devices list, and determine whether to disassociate the first subnet when a second client device is removed from the connected client devices list.

In some implementations, a computer readable medium is provided for the router or any of the network devices described herein. The computer readable medium comprises computer executable code configured to perform the various processes described herein.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 shows a system environment for connecting client devices to a router;

FIG. 2 shows a method for configuring a router;

FIG. 3 shows another method for configuring a router; and

FIG. 4 shows still another method for configuring a router.

Although similar reference numbers may be used to refer to similar elements for convenience, it can be appreciated that each of the various example implementations may be considered distinct variations.

### DETAILED DESCRIPTION

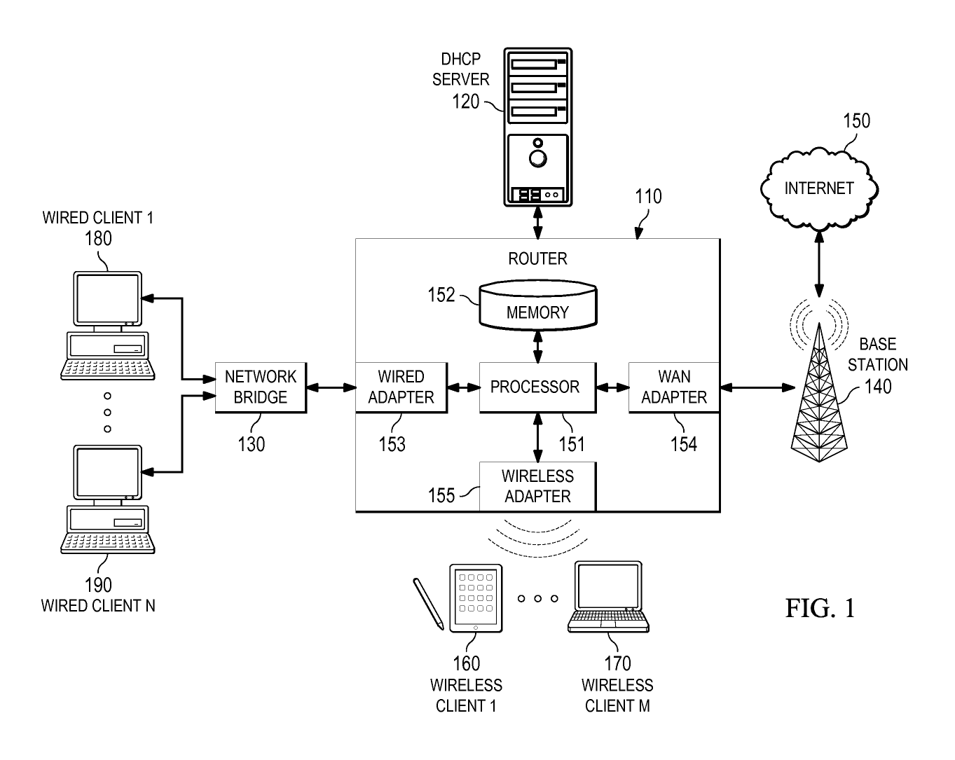

FIG. 1 shows a system environment for connecting client devices to a router 110. FIG. 1 shows a router 110 comprising a memory 152, a processor 151, a wired adapter 153, a wide area network (WAN) adapter 154, and wireless adapter 155. The router 110 is connected, using any wired or wireless communication protocol-based connection, to a Dynamic Host Configuration Protocol (DHCP) server 120. In alternate implementations, the router 110 and the DHCP server 120 may comprise a single entity. The router 110 is connected, using any wireless communication protocol (e.g., Wi-Fi, Bluetooth®, WiMAX, tunneled direct link setup (TDLS), peer-to-peer, wireless mesh, IEEE 802.11, etc.), to wireless clients 160 and 170 via the wireless adapter 155. The router 110 is connected, using any wired communication protocol (e.g., Ethernet, powerline communication (PLC), Universal Serial Bus (USB), etc.) to wired clients 180 and 190 via the wired adapter 153 and the network bridge 130. Although not shown, other client devices may be connected to the router 110 via direct wired connections or indirect wireless connections via intermediate network devices. The router 110 is connected, using any wired and/or wireless communication protocol, to the base station 140 and the Internet 150 via the WAN adapter 154. In some implementations, the wired adapter 153, the wireless adapter 155, or the WAN adapter 154 may include analog front end (AFE) units, antennas, processors, memory, other logic, and/or other components to implement the communication protocols and related functionality.

The processor 151 may control any of the other modules and/or functions performed by the various modules in the router 110. Any actions described as being taken by the processor 151 may be taken by the processor 151 alone or by the processor 151 in conjunction with one or more additional modules. Additionally, while only one processor may be shown in certain devices, multiple processors may be present. Thus, while instructions may be discussed as being executed by the processor 151, the instructions may be executed simultaneously, serially, or otherwise by one or multiple processors. The processor 151 may be implemented as one or more CPU chips and may be a hardware device capable of executing computer instructions. The processor 151 may execute instructions, codes, computer programs, or scripts. The instructions, codes, computer programs, or scripts may be received from memory 152, wired adapter 153, WAN adapter 154, and/or wireless adapter 155.

An I/O module associated with the router 110 may comprise at least one member selected from the group consisting of the wired adapter 153, the wireless adapter 155, or the WAN adapter 154. While presented separately, the adapters in FIG. 1 may be a single adapter providing functions of the separate adapters. The I/O module may include modems, modem banks, Ethernet devices, universal serial bus (USB) interface devices, serial interfaces, token ring devices, fiber distributed data interface (FDDI) devices, wireless local area network (WLAN) devices or device components, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. In some implementations, the I/O module may also include or be connected to liquid crystal displays (LCDs), touch screen displays, keyboards, keypads, switches, dials, mice, track balls, voice recognizers, card readers, paper tape readers, printers, video monitors, or other well-known input/output devices.

As used herein, memory 152 may include random access memory (RAM), read only memory (ROM), or various forms of secondary storage. RAM may be used to store volatile data and/or to store instructions that may be executed by a processor. For example, the data stored may be a command, a current operating state of a device, an intended operating state of a device, etc. ROM may be a non-volatile memory device that may have a smaller memory capacity than the memory capacity of a secondary storage. ROM may be used to store instructions and/or data that may be read during execution of computer instructions. Access to both RAM and ROM may be faster than access to secondary storage. Secondary storage may be comprised of one or more disk drives or tape drives and may be used for non-volatile storage of data or as an over-flow data storage device if RAM is not large enough to hold all working data. Secondary storage may be used to store programs that may be loaded into RAM when such programs are selected for execution.

As used herein, networks may represent any form of network between connected machines and any other network elements or devices presented in FIG. 1, and may also represent a collection of machines or virtual machines operable to provide cloud computing services to users. Networks may include a public cloud or a private cloud. Networks may include routers, hubs, switches, firewalls, content switches, gateways, call controllers, and/or any other suitable components in any suitable form or arrangement. Networks may include, in whole or in part, one or more secured and/or encrypted Virtual Private networks (VPNs) operable to couple one or more network elements together by operating or communicating over elements of a public or external network. A network as described herein may be a wired or wireless network.

The router 110 may serve as a local DHCP server that provides network addresses (e.g., Internet Protocol (IP) addresses) to the client devices 160, 170, 180, and 190 based on DHCP configuration settings (e.g., subnet settings defining a range of allocatable network addresses). As used herein, a subnet is a portion of a network that shares a common network address component (e.g., a network address prefix). The router 110 may also maintain a list of client devices 160, 170, 180, and 190 (e.g., in a connected client devices list), where the list may include information such as allocated network addresses (associated with a subnet range), lease times associated with the network addresses, and connection types (e.g., direct or indirect) for each client device. A network address may be a private network address associated with a particular network. Any feature or function applicable to or performed by the DHCP server 120 may be applicable to and performed by the router 110. Any feature or function applicable to or performed by the router 110 may be applicable to and performed by the DHCP server 120.

The router's DHCP configuration settings may occasionally change, either manually (e.g., reconfiguration by an administrator of the network) or automatically (e.g., when the router 110 is restarted). Wireless or wired client devices that are connected directly to the router 110 may be alerted of the changes to the DHCP configuration settings because the router 110 can “bring down” or toggle the links to these devices, prompting the client devices to request new network addresses in the new subnet range. As used herein, toggling may refer to resetting, or deactivating and reactivating the links to these devices. For example, a wireless interface (e.g., the Wi-Fi interface) may be brought down and brought up again such that the wireless devices are able to request and receive new network addresses from the router 110. However, the router 110 may not be able to bring down links of the client devices 180, 190 that are indirectly connected to the router 110 through a network bridge 130. Accordingly, such client devices may not recognize that the DHCP configuration settings of the router 110 have changed. These changes could potentially invalidate the client devices' 180 and 190 existing network addresses. Subsequent communications between the client devices 180 and 190 and the router 110 may then fail as the headers on outgoing packets from the router 110 would reference network addresses that are no longer recognized by the router 110 (e.g., a network address in an unsupported subnet). Therefore, data services (e.g., network access) on the client devices 180 and 190 are halted. This would require users to manually restart (e.g., unplug and replug) the connections at the client devices 180 and 190 (e.g., to the network bridge) in order to restart data services.

Disclosed are methods, systems, and computer readable media to ensure that changes to DHCP configuration settings at a router 110 do not disrupt communications between the router 110, client devices 160, 170, 180, 190, and a broader external network, regardless of whether the client devices are connected directly to the router or through a network bridge.

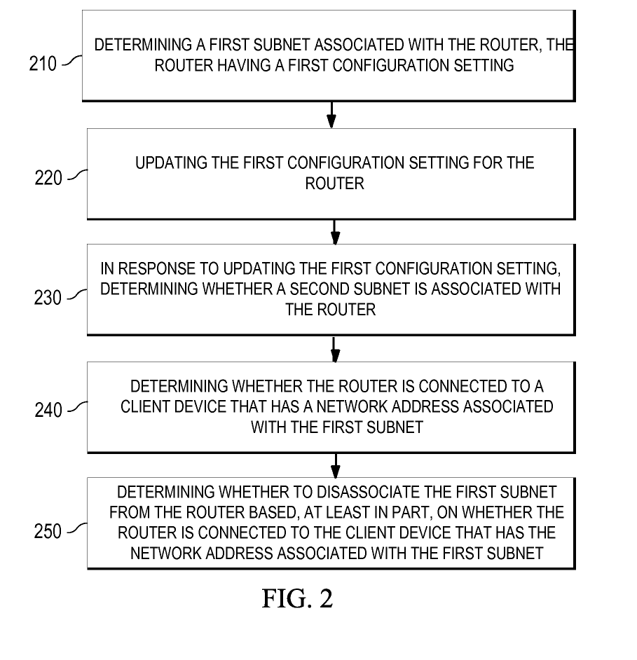

Any of the features described herein with respect to one of the methods are applicable to any of the other methods. FIG. 2 shows a method for configuring a router 110. At block 210, the method comprises determining a first subnet associated with the router 110. The first subnet may comprise or be associated with a first group of network addresses (e.g., 192.168.221.20 to 192.168.221.60). At block 220, the method comprises updating or changing a router configuration setting for the router. At block 230, the method comprises associating a second subnet with the router 110. The second subnet may comprise or be associated with a second group of network addresses (e.g., 192.168.221.70 to 192.168.221.110). The association of the second subnet with the router 110 occurs after updating or refreshing a configuration setting of the router. Updating the configuration setting does not automatically result in the first subnet being disassociated from the router 110. At block 240, the method comprises determining whether the router 110 is connected to a client device that has a network address in the first subnet. At block 250, the method comprises determining whether to disassociate the first subnet from the router 110 based on determining whether the router 110 is connected to the client device that has the network address in the first subnet. Any connection between the router 110 and the client device may be a direct wired connection, an indirect wired connection via a network bridge 130, a direct wireless connection, or an indirect wireless connection via an intermediate network device.

In some implementations, the router 110, upon being reconfigured to support the second subnet, checks a connected client devices list for any bridged devices or other devices (e.g., directly or indirectly connected devices) that may not be alerted or informed about the second subnet (e.g., a device unable to be contacted by the router 110, a device that has not sent a network address renewal request to the router 110 in response to the router 110 sending out a notification that the router's configuration settings have changed, etc.). If bridged devices or other devices that may not have been alerted about the second subnet are found, the router 110 can continue to support the first subnet, as well as support the second subnet, such that the router 110 can continue to support devices having network addresses in the first subnet. As a result, the router 110 may be addressable by multiple network addresses associated with two subnets from a single interface. In some implementations, the first subnet and the second subnet may not have overlapping network addresses. In other implementations, the first subnet and the second subnet have overlapping network addresses. The router 110 may later disassociate itself from the first subnet and associated network addresses when the router 110 determines that no client devices remain in the first subnet, as indicated by the connected client devices list. In some implementations, this determination may occur periodically or whenever a client device is removed from the connected client devices list. As used herein, a network address refers to not only a network address but also a DHCP parameter associated with the network address. In some implementations, the network address may be comprised in a set of DHCP parameters. Therefore, a network address, as used herein, may refer to a set of DHCP parameters including the network address. The network address may either be a private network address or a public network address.

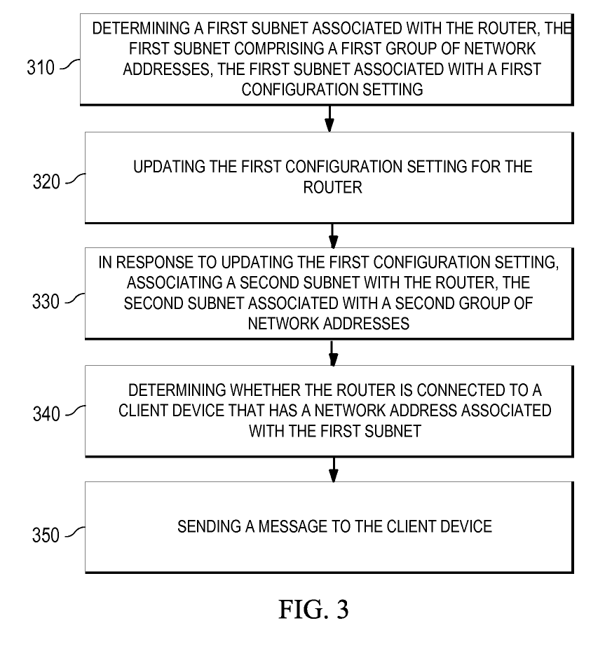

FIG. 3 shows a method for configuring a router 110. At block 310, the method comprises determining a first subnet associated with the router 110. The first subnet may comprise or be associated with a first group of network addresses (e.g., 192.168.221.20 to 192.168.221.60). At block 320, the method comprises updating or changing a router configuration setting for the router. At block 330, the method comprises associating a second subnet with the router 110. The second subnet may comprise or be associated with a second group of network addresses (e.g., 192.168.221.70 to 192.168.221.110). The association of the second subnet with the router 110 occurs after updating or refreshing a configuration setting of the router. Updating the configuration setting does not automatically result in the first subnet being disassociated from the router 110. At block 340, the method comprises determining the router 110 is connected to a client device that has a network address in the first subnet. At block 350, the method comprises sending a message to the client device.

In some implementations, the router 110, upon being reconfigured to support the second subnet, sends a unicasted message to a particular client device detected on the first subnet alerting the client device that its network address will become invalid (e.g., within a predetermined period) or has already become invalid. The message may also inform the client device of the availability of the second subnet. This causes the client device to send a network address renewal request message to the router 110, so that the router 110 can provide the client device with a new network address (along with a lease period for the new network address) in the second subnet. Upon receiving the new network address, the client device configures itself to the new network address. This implementation allows the router 110 to more immediately convey, to the client device, any other new DHCP parameters (e.g., associated with the new network address) that may improve data rates (e.g., between the router 110 and the client device) such as a maximum transmission unit (MTU) size supported by the backhaul connection to the router 110. Alternatively, the message can be broadcast or multicast to multiple client devices, and the client devices may determine whether or not they need to renew their network address (e.g., based on whether their current network address falls in the second subnet range supported by the router 110).

As another implementation, the router 110 may, upon being reconfigured to support the second subnet, send a unicasted message to a particular client device detected on the first subnet. The message includes the new network address (along with corresponding DHCP parameters) associated with the second subnet. An application may need to be installed on the client device that detects this message and then reconfigures the client device using the new network address. In this implementation, the client device may be able to reconfigure itself to the new network address without having to send a network address renewal request to the router 110. Alternatively, the message can be broadcast to multiple client devices, and the client devices may determine whether or not they need to renew their new network address (e.g., based on whether their current network address falls in the second subnet range supported by the router 110).

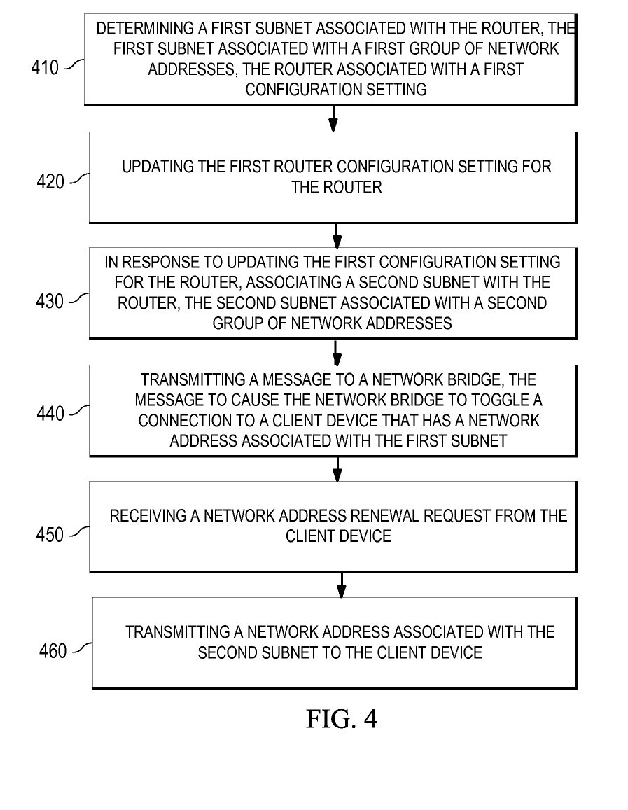

FIG. 4 presents another method for configuring a router 110. At block 410, the method comprises determining a first subnet associated with the router 110. The first subnet may comprise or be associated with a first group of network addresses (e.g., 192.168.221.20 to 192.168.221.60). At block 420, the method comprises updating or changing a router configuration setting for the router. At block 430, the method comprises associating a second subnet with the router 110. The second subnet may comprise or be associated with a second group of network addresses (e.g., 192.168.221.70 to 192.168.221.110). The association of the second subnet with the router 110 occurs after updating or refreshing a configuration setting of the router. Updating the configuration setting does not automatically result in the first subnet being disassociated from the router 110. At block 440, the method comprises transmitting a message to a network bridge 130 triggering the network bridge 130 to toggle the network bridge's connection to a client device that has a network address in the first subnet. Therefore, the router 110, upon being reconfigured to support the second subnet, transmits a message to a network bridge 130 to toggle or restart the network bridge's downstream connections to client devices (e.g., through an auto-negotiation restart or toggle of an Ethernet link). At block 450, the method comprises receiving a network address renewal request from the client device. At block 460, the method comprises transmitting a new network address associated with the second subnet to the client device in response to receiving the network address renewal request from the client device.

In some implementations, any of the devices shown in FIG. 1 may take the form of, comprise, or be comprised in any device with a network interface, which includes, but is not limited to, a router, an access point, a range extender, a network component, a computing device, a desktop computer, a node, a virtual machine, an instance, a host, a laptop, a mobile device, a fan, a light, a headless device (e.g., without a user interface), an air-conditioner, a thermostat, a microwave, a watch or wristband, glasses or other eyewear, a laptop computer, a smart screen, a tablet computer, a desktop computer, an electronic reader, a scanner, a portable media player, a mobile computing device, a mobile phone, a wearable device (e.g., wearable on a user's arm), headgear, a gaming device, or a kiosk. As used herein, the terms node, device, device component, network device, system, and apparatus are substantially equivalent and may be used interchangeably.

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

What is claimed is:

1. A method for configuring a router on a network, the method comprising:
determining a first subnet associated with the router, the router having a first configuration setting;
updating the first configuration setting for the router;
in response to updating the first configuration setting, determining whether a second subnet is associated with the router;
determining whether the router is connected to a client device that has a network address associated with the first subnet; and
determining whether to disassociate the first subnet from the router based, at least in part, on whether the router is connected to the client device that has the network address associated with the first subnet.

2. The method of claim 1, wherein the router comprises a wired adapter, a wireless adapter, or a wide area network (WAN) adapter.

3. The method of claim 1, further comprising:
disassociating the first subnet in response to determining that no client device has a network address associated with the first subnet.

4. The method of claim 1, further comprising retaining the association of the first subnet in response to determining that the client device has the network address associated with the first subnet.

5. The method of claim 1, further comprising determining whether the router is connected to the client device based on accessing a connected client devices list.

6. The method of claim 5, further comprising determining whether to disassociate the first subnet when a second client device is removed from the connected client devices list.

7. The method of claim 1, wherein the connection between the router and the client device is a direct wired connection, an indirect wired connection, a direct wireless connection, or an indirect wireless connection.

8. The method of claim 1, wherein the first subnet does not overlap with the second subnet.

9. The method of claim 1, wherein the network address is associated with at least one Dynamic Host Configuration Protocol (DHCP) parameter.

10. The method of claim 1, wherein the router is connected to the client device that has the network address associated with the first subnet, further comprising notifying the client device of the second subnet.

11. The method of claim 1, wherein the router is connected to the client device that has the network address associated with the first subnet, further comprising:
receiving, from the client device, a network address renewal request; and
transmitting, to the client device, a network address associated with the second subnet, in response to receiving the network address renewal request from the client device.

12. The method of claim 1, wherein the router is connected to the client device that has the network address associated with the first subnet, further comprising unicasting a message to the client device or broadcasting the message to multiple client devices.

13. The method of claim 1, wherein the router is connected to the client device that has the network address associated with the first subnet, further comprising:
sending a message to the client device, wherein the client device determines whether to send a network address renewal request to the router based on the message.

14. A method for configuring a router on a network, the method comprising:
determining a first subnet associated with the router, the first subnet associated with a first group of network addresses, the router associated with a first configuration setting;
updating the first router configuration setting for the router;
in response to updating the first configuration setting for the router, associating a second subnet with the router, the second subnet associated with a second group of network addresses;
transmitting a message to a network bridge, the message to cause the network bridge to toggle a connection to a client device that has a network address associated with the first subnet;
receiving a network address renewal request from the client device; and
transmitting a network address associated with the second subnet to the client device.

15. The method of claim 14, wherein toggling the network bridge comprises resetting the network bridge or deactivating and re-activating the network bridge.

16. A router comprising:
a memory; and
a processor, coupled to the memory, and configured to:
determine a first subnet associated with the router, the router having a first configuration setting;
determine whether the first configuration setting of the router has changed;
determine, in response to a determination that the first configuration setting has changed, whether the router is connected to a client device that has a network address associated with the first subnet; and
determine whether to disassociate the first subnet from the router based, at least in part, on whether the router is connected to the client device that has the network address associated with the first subnet.

17. The router of claim 16, wherein the processor is further configured to disassociate the first subnet in response to determining that no client device has a network address associated with the first subnet.

18. The router of claim 16, wherein the processor is further configured to retain the association of the first subnet in response to determining that the client device has the network address associated with the first subnet.

19. The router of claim 16, wherein the processor is further configured to determine whether the router is connected to the client device based on accessing a connected client devices list, and determine whether to disassociate the first subnet when a second client device is removed from the connected client devices list.

20. The router of claim 16, further comprising a wired adapter, a wireless adapter, or a wide area network (WAN) adapter.
